(19) United States
(12) Patent Application Publication
(10) Pub. No.: US 2006/0175325 A1
(43) Pub. Date: Aug. 10, 2006

(54) Impact modified polyester and vinylalcohol copolymer blend and molded fuel tank thereof

(76) Inventor: Eric D. Day, Florence, KY (US)

Correspondence Address: FERRELLS, PLLC, P. O. BOX 312, CLIFTON, VA, 20124-1706, US

(21) Appl. No.: 11/053,245

(22) Filed: Feb. 8, 2005

(51) Int. Cl. B65D 6/00; B32B 27/36; C08L 29/04; C08L 67/00; B32B 37/00

(52) U.S. Cl. 220/4.14; 428/480; 525/58; 525/437

(57) ABSTRACT

A blended composition having a polyester component, an olefin-vinylalcohol component, and an impact modifier component. The compositions of the present invention may be formed into containers and are specifically suitable for making fuel tanks.

### TECHNICAL FIELD

The present invention relates generally to a polymer blend including a polyester, an olefin-vinylalcohol copolymer, and an impact modifier. The compositions of the present invention exhibit superior impact resistance and permeation barrier properties. The compositions exhibit remarkable barrier to gasoline permeation and are thus especially suitable for fuel tanks.

### BACKGROUND

Small fuel tanks, such as those used by small off-road vehicles, are typically made from high density polyethylene (“HDPE”). HDPE, while having good impact strength properties, does not exhibit superior permeation barrier properties. Because of this, HDPE fuel tanks have a tendency to release evaporative emissions at undesirable levels. Increasing environmental concerns (and pending EPA regulations) over fuel emissions are promoting the need for compositions that have good fuel barrier properties. Also, because fuel tanks must maintain their integrity under somewhat arduous conditions, a need exists to make fuel tanks from compositions that exhibit both good strength properties as well as good barrier properties.

Aromatic polyesters such as polybutylene terephthalate (“PBT”) and the like have excellent heat resistance and chemical resistance properties. However, these polyesters need to be impact-modified in order to be suitable for certain parts. Similarly, vinylalcohol copolymers, such as ethylene vinylalcohol copolymers, are known for their barrier properties, but tend to be brittle. Some representative references are noted briefly below.

Blends of polyesters and vinylalcohol copolymers claiming to have good barrier properties have been described in the prior art. For example, European patent application 0 350 224 to Fukusawa et al. discloses blends of PBT and an olefin-vinylalcohol copolymer. The PBT resin is present in an amount from 50 to 95 wt. %. The olefin-vinylalcohol copolymer is present in an amount of 5 to 50 wt. %. Fukusawa states that its polymer blends have good barrier properties and exhibit reduced heat shrinkage.

U.S. Pat. No. 4,284,550 to Mizuno et al. discloses another polymer composition incorporating polyesters and vinylalcohol copolymers. Mizuno et al. discloses a composition containing PBT, an organohalogen compound, a flame retardant supplementary agent, calcium sulfate, an inorganic fibrous reinforcing agent, and optionally, EVOH. The polymer compositions in Mizuno et al. are used as flame-retardants to decrease the time it takes for the afterglow of a fire to remain after the flame expires.

It has also been attempted to improve the impact strength of polyester resins by adding impact modifiers. For example, U.S. Pat. No. 5,854,346 discloses a blend of 100 parts polyester and 5-20 parts of an impact modifier. The impact modifier used is itself a blend of a core/shell impact modifier and a linear olefin copolymer. Similarly, U.S. Pat. No. 6,809,151 discloses a composition where a polyester is mixed with an impact modifier comprising a core/shell copolymer, and ethylene-unsaturated carboxylic acid anhydride copolymer or ethylene-unsaturated epoxide copolymers. The composition is reported to have improved impact properties, including low-temperature toughness.

Various fillers have been added to polyester resins in known compositions. United States Patent Application No. 2003/0100655 discloses polyester nanocomposites having a matrix polymer, a block copolymer, and clay where the clay is intercalated with the block copolymer. The block copolymer is selected to have hydrophilic blocks which are compatible with the clay and oleophilic blocks which are compatible with the matrix polymer. The matrix polymer may comprise polyesters such as PBT. The resulting compositions are reported to have improved physical properties including impact resistance, electrical conductivity, and oxygen and water barrier properties.

Decreasing the permeability of fuel tanks by employing a vinylalcohol copolymer has been attempted in the prior art. U.S. Pat. No. 6,391,412 to Hata et al. discloses a plastic fuel tank of multi-layer construction having outer layers of HDPE and an inner layer of ethylene-vinylalcohol copolymer (“EVOH”). The tanks of Hata et al. are reported to have improved gasoline barrier properties and higher impact resistance. U.S. Pat. No. 6,395,357 to Abu-Isa similarly discloses a fuel tank which employs EVOH has a fuel permeation barrier layer.

Despite these advancements, what is needed, especially for fuel tanks, is a plastic composition with effective barrier properties which also has good impact resistance. It is seen, for example, that impact modifiers have a deleterious effect on the permeation barrier properties of polyester.

It has been discovered in accordance with the present invention that a composition containing polyester, olefin-vinylalcohol copolymer, and impact modifier exhibits unexpectedly superior permeability and impact properties.

### SUMMARY OF INVENTION

The present invention resides, in part, in the discovery that impact modified polyesters and vinylalcohol copolymer blends exhibit remarkable reductions in fuel permeation rates as compared with impact modified polyester compositions. For example, compositions of the invention have a gasoline permeation rate orders of magnitude lower than corresponding polyester/impact modifier compositions. The inventive compositions also exhibit superior mechanical properties as is required for fuel tanks.

There is thus provided in one aspect, an impact resistant composition with low permeability which comprises a polyester component in the amount of between about 20 PHR and about 90 PHR, an olefin-vinylalcohol component in the amount between about 5 PHR and about 60 PHR, and an impact modifier component which is present in an amount between about 5 PHR and about 40 PHR. The polyester component is selected from the group consisting of polyethylene terephthalate, polybutylene terephthalate, copolymers of PBT and PET, or blends thereof. In preferred embodiments the compositions of the present invention are melt-blended.

The polyester component is typically present in an amount between about 25 and 70 PHR and preferably includes polybutylene terephthalate. The olefin-vinylalcohol component is suitably present in ranges from between about 7 PHR to about 25 PHR. The olefin-vinylalcohol component usually includes a copolymer of ethylene and vinylalcohol having a preferred ethylene content of between about 20 and about 40 mol %. The ethylene-vinylalcohol copolymer is typically made by the saponification of an ethylene-vinyl acetate copolymer, with a desired degree of saponification of at least about 90 mol %.

The impact modifier component of the composition is generally present in an amount of between about 10 PHR to about 35 PHR. The impact modifier component preferably comprises a core/shell modifier which is selected from either MBS impact modifiers, Acrylic modifiers, or combinations thereof.

The compositions of the present invention may optionally be blended with about 0.01 PHR to about 20 PHR of additional polymeric components. For example, the composition can be blended with nylon or thermoplastic elastomer polyester resins. A number of additional components may be added to the compositions of the present invention including nucleants, antioxidants, lubricants, and heat stabilizers. Reinforcing agents may also optionally be added to the inventive compositions in the amount of about 0.01-50 wt. % based on the weight of the blended composition. If reinforcing agents are used, it is usually in the form of glass fiber.

A shaped article comprising the composition of the present invention is also provided herein. The shaped article is typically formed by an extrusion process. The present invention further encompasses a multilayered structure which incorporates a layer of the inventive compositions. The multilayered structure may further include at least one layer comprising an oxymethylene polymer.

In another aspect of the present invention there is provided a container which comprises the inventive compositions. Exemplary methods for producing the container include blow-molding, extrusion blow-molding and injection molding. In preferred embodiments, a fuel tank is provided which incorporates the compositions of the present invention. In especially preferred embodiments, the fuel tank has at least one wall that consists essentially of the compositions of the present invention and has a wall thickness of about 0.5-6 mm. The fuel tank typically has a capacity of less than about 20 gallons.

Suitably, the fuel tanks provided in accordance with the present invention are made from a composition having a characteristic gasoline permeation of less than about 3 gm-mm/m²-day, and preferably about 0.5 gm-mm/m²-day, at 40° C. In especially preferred embodiments the composition has a characteristic gasoline permeation of less than about 0.05 gm-mm/m²-day. Typically, the composition included in the fuel tanks also has a characteristic oxygen permeation of less than about 1 cc-mm/m²-day when tested at 23° C. with 100% oxygen on the test gas side of the diffusion cell at 1 atm. Also, the tank may be made from compositions of the present invention which have a characteristic notched izod strength of at least about 7 kJ/m². The compositions also generally have a characteristic multiaxial impact energy (“MAI energy”) of at least about 18 ft-lbf, and preferably at least about 30 ft-lbf, when tested at an impact velocity of 7.2 ft/s.

In another aspect of the invention there is provided a method of making a fuel tank whereby a parison is extruded which comprises a blend of polybutylene terephthalate (in amounts of about 20 PHR to about 90 PHR), ethylene-vinylalcohol copolymer (in amounts of about 5 PHR to about 60 PHR), and impact modifier (in amounts of about 5 PHR to about 40 PHR). The parison is then blow-molded into the shape of the fuel tank.

The foregoing and other features of the invention will become apparent from the discussion which follows.

### BRIEF DESCRIPTION OF DRAWING

The invention is described in detail below in connection with the appended drawings wherein like numerals designate like parts and wherein:

FIG. 1 is a graph on a logarithmic scale of the gasoline permeation values obtained in Example 1 and Comparative Example 8.

FIG. 2 is a bar graph of oxygen permeation values of the compositions in Examples 1-3 and Comparative Examples 4-8.

FIG. 3 is a bar graph of MAI energy of the compositions in Examples 1-3, and Comparative Examples 4-8.

FIG. 4 is a view in perspective of a fuel tank of the present invention.

### DETAILED DESCRIPTION OF THE INVENTION

The invention is described in detail below with reference to numerous embodiments for purposes of exemplification and illustration only. Modifications to particular embodiments within the spirit and scope of the present invention, set forth in the appended claims, will be readily apparent to those of skill in the art.

Unless more specifically defined, terminology is given its ordinary meaning.

“Polyester”, “polyester component” and like terminology refers to polymers which are typically obtained by the condensation of glycols and of dicarboxylic acids, or of their derivatives. Aromatic polyesters, such as polyethylene terephthalate and polybutylene terephthalate, are typically derived from the condensation of aromatic dicarboxylic acids and at least one glycol. PBT, a particularly preferred polyester for the composition of the present invention, can be made by polymerizing a glycol component containing about 70-80 mole % tetramethylene glycol and an acid component at least 70 mole %, preferably at least 80 mole %, of which consists of terephthalic acid, or polyester-forming derivatives thereof. Also contemplated are mixtures of the ester with minor amounts, e.g., from 0.5 to 5% by weight, of units derived from aliphatic or other aromatic dicarboxylic acids and/or aliphatic polyols, e.g., glycols, i.e., copolyesters. Among the units which can be present in the copolyesters are those derived from aliphatic dicarboxylic acids, e.g., of up to about 50 carbon atoms, including straight and branched chain acids, such as adipic acid, dimerized C₁₆-C₁₈ unsaturated acids (which have 32 to 36 carbon atoms), trimerized such acids, and the like. Among the units in the copolyesters can also be minor amounts derived from other aromatic dicarboxylic acids, e.g., of up to about 36 carbon atoms, such as isophthalic acids and the like. Such polyesters can be made by techniques well known to those skilled in the art. For example, production of polyesters is disclosed in U.S. Pat. No. 3,047,539, the entirety of which is herein incorporated by reference. An acceptable polyester for use in the present invention is a PBT that is commercially available under the tradename CELANEX® (Ticona).

“Olefin-vinylalcohol copolymers,” “olefin-vinylalcohol copolymer component” and like terminology refers to copolymers of an olefin and a vinylalcohol, as well as blends thereof, which may be prepared by the saponification of a copolymer comprising an olefin having 2 to 6 carbon atoms and a vinyl ester such as vinyl acetate. The resulting olefin-vinylalcohol copolymers achieve progressively better barrier properties as the degree of saponification increases. Accordingly, it is desirable for the compositions of the present invention to employ an olefin-vinylalcohol copolymer with a degree of saponification of at least about 90%. Aside from the olefin and vinyl ester monomers, other monomers capable of copolymerizing with them may be present in minor amounts. Additional monomers may include other olefin monomers, unsaturated acids, methacrylic acid, crotonic acid, maleic acid and itaconic acid, and their anhydrides, salts, or mono- or di-alkyl esters; nitrites such as acrylonitrile and methacrylonitrile; amides such as acrylamide and methacrylamide; olefinsulfonic acids such as ethylenesulfonic acid, allylsulfonic acid and methallylsulfonic acid, and their salts; alkyl vinyl ethers, vinyl ketones, N-vinylpyrrolidone, vinyl chloride and vinylidene chloride. A preferred vinylalcohol copolymer is poly(ethylene vinylalcohol) or EVOH. EVOH is produced by the saponification of an ethylene-vinyl acetate copolymer (“EVAc”). Typically, the saponification of EVAc takes place in the presence of an alkali catalyst in a methanol solution. The inventive compositions typically employ EVOH copolymers that have an ethylene content of between about 20 and about 40 mol %. Methods for producing EVOH are detailed in U.S. Pat. No. 6,800,687; U.S. Pat. No. 6,613,833; and U.S. Pat. No. 6,538,064, the entireties of which are incorporated herein by reference. Acceptable commercially available EVOH for use in the present invention includes EVAL™ resins (Eval Europe).

“Impact modifiers,” “impact modifier component” and such terminology refers to components used to toughen engineering resin compositions. Impact modifiers include core-shell elastomers, ethylene/methacrylate copolymers, ionomers and so forth as are known in the art. Core-shell modifiers are typically composed of a crosslinked elastomeric core and a thermoplastic shell. The sizes of the core-shell particle generally range from about 50-500 nm. The elastomeric core may comprise acrylic monomers, such as butyl acrylate, or a copolymer of styrene and butadiene. “MBS” impact modifiers refers to core-shell modifiers made of methacrylate-butadiene-styrene copolymer where the core is styrene-butadiene, and the shell is methacrylate. “Acrylic” impact modifiers or “AIMs” refers to modifiers with cores of acrylic monomers. The thermoplastic shell of core-shell modifiers are made of materials that include styrene homopolymers, alkylstyrene homopolymers, and methyl methacrylate homopolmers or copolymers. U.S. Pat. No. 5,854,346, the entirety of which is incorporated herein by reference, discloses impact modifiers that are reported to improve the impact strengths of aromatic polyesters. An acceptable commercially available impact modifier for use with the present invention is Kane Ace (Kaneka).

“PHR” means parts per hundred weight resin. For example, a composition which consists of 40 wt. % polyester, 40 wt. % EVOH and 20 wt. % impact modifier and a composition which consists of 20 wt. % polyester, 20 wt. % EVOH, 10 wt. % impact modifier and 50 wt. % glass reinforcement both have 40 PHR polyester, 40 PHR ethylene vinylaclohol copolymer and 20 PHR impact modifier.

“Melt-blended” as used herein refers to the blending together of at least two of the components of the composition of the present invention while the components are in their melted state.

“Characteristic gasoline permeability”, “gasoline permeation” and like terminology refers generally to the barrier properties of a plastic composition, particularly the tendency to allow the transmission of gasoline or fuel across a film made from the plastic composition. The characteristic gasoline permeation of a composition as reported in the Examples below and as quantified in the claims, is measured using the following modified isostatic procedure: 1/32″ thick discs are prepared from the sample compositions. The discs are secured in a cell with a fuel mixture on one side and a carrier gas flowing on the other. The fuel cell is in an isostatic state. The fuel used in the test can be any typical gasoline and should contain about 11% methyl tertiary butyl ether. Any flux through the sample is picked up by the carrier flow, separated in a capillary column and analyzed by a flame ionization detector. The temperature of the samples and the test fuel are maintained at 40±0.25° C. The measured transmission rate of gasoline is then normalized to permeation units, i.e., gm-mm/m²-day.

The components of the compositions of the present invention, i.e., the polyester, the olefin-vinylalcohol copolymer, and the impact modifier, may be blended with other polymeric components as well. The additional-polymers are not restricted, so long as they do not alter the basic and novel characteristics of the invention, that is, superior barrier and mechanical properties. For example, the compositions should have a characteristic gasoline permeation of less than about 5 gm-mm/m²-day. If the presence of additional polymers are desired in polyester/olefin-vinylalcohol blend, suitable polymers may include other homopolymers or copolymers of amides, acetates, anhydrides, or additional polyolefins or esters. The additional polymers may be present in an amount between about 0.01 PHR and about 20 PHR. An acceptable polymer that may be blended with the composition of the present invention is a thermoplastic polyester elastomer, such as those commercially available under the tradename RITEFLEX® (Ticona). Another suitable polymer that may be included in the blend is amorphous nylon, which may be obtained under the designation SELAR® (DuPont).

A particularly preferred embodiment of the present invention contains approximately 59 wt. % of the PBT component, 10 wt. % of EVOH, 23 wt. % impact modifier, and 7 wt. % of thermoplastic polyester elastomer.

Reinforcing agents or fillers may also be combined with the inventive resin compositions. The reinforcing agents used are typically reinforcing fibers. Suitable reinforcing agents include, for example, glass fiber, carbon fiber, ceramic fiber, fibrous potassium titanate, iron whiskers, and the like. Glass is the most preferred. While fiber is the most preferred form for the reinforcing agent, other suitable forms may also be employed in the practice of the invention. Where reinforcing fibers are used, such fibers should normally have diameters between about 5 and about 30 microns. Aspect ratios (ratio of length of fiber to diameter of fiber) are desirably at least about 5. The reinforcing fiber typically has a length prior to compounding of generally from about 1-10 mm. After compounding and/or molding, the fibers are considerably shorter, generally in the range of 0.2-5 mm in length with the average length typically toward the lower value of 0.2 mm. Glass fibers, where used, preferably have diameters between about 10 and about 15 microns and an initial aspect ratio of at least about 20. Fillers, such as calcium carbonate may also be used. If reinforcing agents or fillers are added, it is desirable that they be present in an amount anywhere from about 0.01-50 weight percent, provided they do not alter the basic and novel characteristics of the invention.

It will also be appreciated by one skilled in the art that other additives may be added to the compositions of the present invention without substantially altering the compositions. Such additives include antiblocking agents, antioxidants, UV stabilizers, lubricants, nucleating agents, colorants, and mold release agents.

The compositions of the present invention may be formed into a shaped article such as a pellet, a sheet, a parison, and the like. The article is usually shaped by, for example, an extrusion process. Extrusion processes are well-known in the art. Typically, the composition is melted in an extruder and extruded through a die to form the article. The die is generally flat for flat sheets or annular for tubular shaped articles. The shaped article may then be taken off of the extruder for solidification and optionally stretched for orientation. The extrudate may also be corona- or flame-treated by well-known processes if necessary.

The compositions of the present invention may optionally be incorporated into a multilayered structure comprising other polymeric materials. The multilayered structure can have two or more layers, may be arranged in any order, and may include a tie, or adhesive, layer to bind the separate layers together. Any method of producing the multilayered structure may be used, e.g., co-extrusion, lamination, and co-injection molding, however, co-extrusion is a preferred process. Typically, multilayered structures are produced in co-extrusion processes by melting the components of each layer in separate extruders and passing them through a multimanifold die where the layers are adhered to each other. Acceptable materials that may be used in additional layers include polyolefins, polar polymers, for example homopolymers and copolymers of amides, acetates, anhydrides, and other esters. The layers may also comprise such materials as paper, cardboard, kraft paper, wood, metal, metal foils, metallized surfaces, glass, fabric, other fibers, and surfaces coated with substrates such as ink, dye, and the like. A preferred multilayer structure also incorporates a layer comprising polyoxymethylenes. The term “polyoxymethylenes” refers to polyacetals or oxymethylene homopolymers or copolymers. Oxymethylene polymers are commercially available from under the tradename CELCON® (Ticona).

The compositions of the present invention may be formed into containers by any suitable process. Preferably, though, the containers are formed by blow-molding or injection molding. “Blow-molding” is a well-known process for forming hollow products by expanding a hot plastic parison against the internal surfaces of a mold. For large part blow molding, accumulators are used to prevent sagging of the parison. “Extrusion blow-molding” refers to a blow-molding process which is run in sequence with an extrusion process, i.e., a plastic is extruded to form a parison, which is subsequently blow-molded. Where multilayered containers are desired, the blow-molding process may be run in sequence with a co-extrusion process. Injection molding or co-injection molding processes may also be used to make containers incorporating a multilayered structure.

The compositions of the present invention are specifically suitable for forming or being incorporated in a fuel tank due to their increased strength and improved barrier properties. The fuel tank may be a multilayered structure, but preferably should have single layered walls consisting essentially of the composition of the present invention. The walls should usually be between about 0.5 mm to about 6 mm thick. Although the capacity of the fuel tank is not specifically limited, lower-capacity (less than 20 gallons) fuel tanks are especially suitable containers to employ the compositions of the present invention. The low-capacity fuel tanks are generally used in applications such as lawn-mowers and off road vehicles. The fuel tanks may be formed by any suitable method, but molding methods such as blow-molding and injection molding are preferred.

### Examples 1-3 and Comparative Examples 4-8

Examples 1-3 and Comparative Examples 4-7 were melt-blended using CELANEX® 1600A as the PBT component, EVAL™ F101A as the EVOH component, Kane Ace M-511 as the impact modifier, and Microtalc MP 12-50 as the talc. The EVOH used in the examples is believed to contain approximately 32 mol % of ethylene. A thermoplastic elastomer (“TPE”) was also added in varying amounts in the form of RITEFLEX® 640 (Ticona). Comparative Example 8 was blended using the same components as the preceding examples with the exception that the PBT component was VANDAR® 4602ZHR (64 wt. % PBT, Ticona). The amount of each component (in wt. %) varies in each example according to Table 1, below.

TABLE 1

| | | | Impact | | |
|---|---|---|---|---|---|
| Example | PBT | EVOH | Modifier | Talc | TPE |
| 1 | 64.5 | 20 | 11 | 0 | 3 |
| 2 | 30.5 | 40 | 22 | 0 | 6 |
| 3 | 30.35 | 40 | 22 | 0.15 | 6 |
| Comparative 4 | 76.5 | 0 | 22 | 0 | 0 |
| Comparative 5 | 92.5 | 0 | 0 | 0 | 6 |
| Comparative 6 | 58.5 | 40 | 0 | 0 | 0 |
| Comparative 7 | 58.35 | 40 | 0 | 0.15 | 0 |
| Comparative 8 | 46.1 | 0 | 22 | 0 | 6 |

Examples 1-3 and Comparative Examples 4-7 also contain 0.4 wt. % of a lubricant, 0.6 wt. % antioxidants, and 0.5 wt. % of an epoxy resin.

The components in Examples 1-3 and Comparative Examples 4-8 were melt-blended and extruded in a ZSK-30 extruder having a SC 387 screw design under the following temperature settings:

| Barrel Zone | Temperature Setting (° C.) |
|---|---|
| 1 | 230 |
| 2 | 230 |
| 3 | 230 |
| 4 | 230 |
| 5 | 230 |
| 6 | 230 |
| Die | 250 |

The melt temperature was set at 290° C. and the screw speed at 250 RPMs. Example 1 was run at a rate of about 45 lbs/hour; Examples 2 and 3 were run at a rate of 40 lbs/hour; Comparative Examples 4 and 5 were extruded at a rate of 30 lbs/hour; Comparative Example 6 was run at 50 lbs per hour; and Comparative Example 7 was run at 40 lbs/hour. Examples 1 and Comparative Examples 4-6 were extruded using a 4 mm X's two hole die plate and Examples 2, 3 and Comparative Example 7 were extruded using a 4 mm X's one hole die plate.

The extrudates were subsequently molded using a 4 oz. Krauss Maffei molding machine. Each example was run in triplicate. For each example, two disc shaped samples were made using a 4″ mold deposit—a 1/32″ thick disc was made using a shot size of 22 mm and an ⅛″ thick disc using a shot size of 40.4 mm. Additionally, for each example a sample was prepared using an ISO frame mold using a shot size of 50.8 mm. The ⅛″ disc was used to measure multiaxial impact energy (“MAI energy”), the 1/32″ disc was used to measure the oxygen transmission rate, and the ISO frame mold was used to produce a universal test specimen for the notched izod impact test. An additional 1/32″ disc was prepared for Example 1 and Comparative Example 8 which was used to measure the gasoline permeation. The molding machine was run at the following temperatures:

| Zone | Temperature Setting (° C.) |
|---|---|
| Rear Barrel | 254 |
| Middle Barrel | 254 |
| Front Barrel | 254 |
| Nozzle | 260 |
| Melt | 260 |
| Moveable Mold | 82 |
| Stationary Mold | 82 |

The resultant samples were then tested for various characteristics using the following methods:

| Property | Test Method |
|---|---|
| Gasoline Permeation | Modified Isostatic |
| Oxygen Permeation | ASTM-D3985-02 |
| Notched Izod Impact | ISO-180 |
| MAI energy | ASTM- D3763-02 |

The modified isostatic test used to determine the characteristic gasoline permeation is discussed in detail above. The oxygen transmission rate test is performed at 23° C., with 100% oxygen in the test gas side of the diffusion cell at 1 atm. As in the gasoline permeation test, the measured oxygen transmission rate is reported in normalized permeation units, i.e., cc-mm/m²-day, to give the characteristic oxygen permeation of the composition. The MAI energy test uses an impact velocity of 7.2 ft/s. The results from these tests are shown below in Table 2.

TABLE 2

| | Gasoline | Oxygen | Notched | |
|---|---|---|---|---|
| | Permeation | Permeation | Izod | |
| | (g-mm/m²- | (cc-mm/m²- | Impact | MAI at 23° |
| Example | day) | day) | (kJ/m²) | C. (ft-lbf) |
| 1 | 0.0006 | 0.67 | 9.2 | 39 |
| 2 | — | 0.5 | 10.2 | 20 |
| 3 | — | 0.39 | 11 | 25 |
| Comparative 4 | — | 3.2 | 80 | 39 |
| Comparative 5 | — | 2.21 | 6.3 | 41 |
| Comparative 6 | — | 0.05 | 4.5 | 1.9 |
| Comparative 7 | — | 0.13 | 4.9 | 2.2 |
| Comparative 8 | 19.7 | 4.58 | 78 | 39 |

Table 2 shows that the compositions of the present invention achieve superior strength and barrier properties.

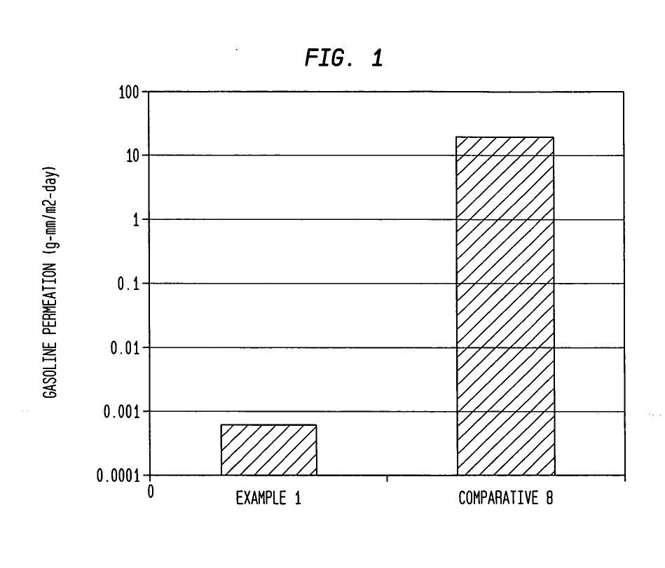

The compositions of the present invention have a remarkably low gasoline permeation. As seen in Table 2, Example 1 exhibited a characteristic gasoline permeation which was several orders of magnitude less than the permeation of Comparative Example 8, which had PBT and impact modifier, but no olefin vinylalcohol copolymer component. Example 1 had a gasoline permeation of only 0.0006 g-mm/m²-day while Comparative Example 8 had a gasoline permeation of 19.7 g-mm/m²-day. The dramatic reduction in gasoline permeation is especially surprising when compared with the reduction in oxygen permeation. The addition of EVOH to the sample (as in Example 1) resulted in an oxygen permeation that was about 14.5% of Comparative Example 8. In contrast, Example 1 had a gasoline permeation of only about 0.003% of Comparative Example 8. Thus, while the compositions of the present invention exhibit low oxygen and gasoline permeations, the magnitude of improvement on the gasoline permeabilities is especially surprising. FIG. 1 shows the relative gasoline permeations of Example 1 and Comparative Example 8. The y-axis in FIG. 1 is on a logarithmic scale. As is apparent from FIG. 1, the compositions of the present invention have a much lower gasoline permeability than other polyester containing compositions.

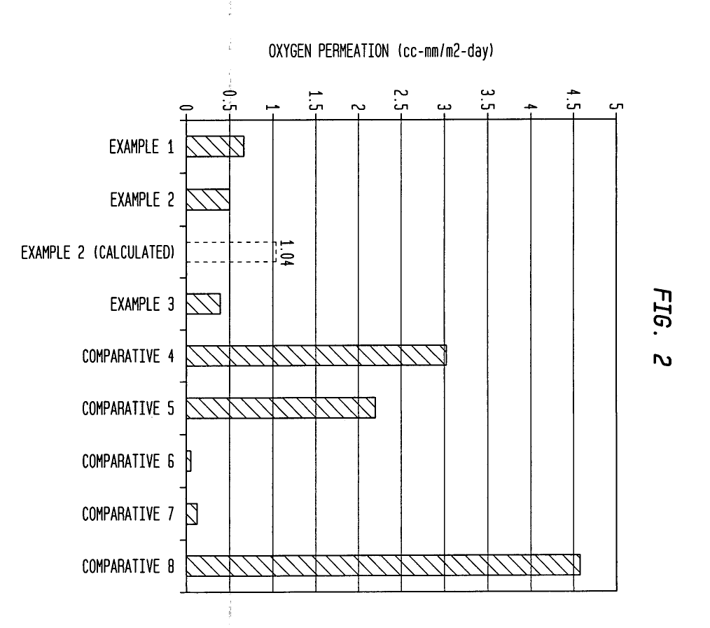

Oxygen permeability is also substantially improved in the compositions of the present invention. Surprisingly, the deleterious effects of impact modifier on oxygen permeation is tempered (even considering the beneficial effects of EVOH) when the impact modifier is present in a PBT/EVOH blend as opposed to PBT alone. For example, when the impact modifier is added to PBT, the oxygen permeation increases by nearly 45% as shown in Comparative Example 4. Adding EVOH to PBT, without impact modifier, decreases the oxygen permeation by nearly 98% (as shown in Comparative Example 6). Thus, a blend of PBT/EVOH with impact modifier could be expected to show a decreased oxygen permeation of about 53% [98%−45%=53%], which is a value of about 1.04 cc-mm/m²-day [2.21 cc-mm/m²-day−(0.53*2.21 cc-mm/m²-day)=1.04 cc-mm/m²-day]. Unexpectedly, however, the composition having PBT/EVOH with impact modifier (in the case of Example 2) exhibits a characteristic oxygen permeation of 0.5 cc-mm/m²-day, which is only about half of the expected value that was calculated. And, when a small amount of talc is added (as in Example 3), the permeation is only about 38% of the predicted value. The measured characteristic oxygen permeations for Examples 1-3 and Comparative Examples 4-8 are illustrated in FIG. 2. Also shown is the oxygen permeation value that Example 2 was calculated to have. FIG. 2 illustrates that the compositions of the present invention have substantially lower oxygen permeations (less than 25%) than Comparative Examples 4, 5, and 8. It is also interesting to note here that while the presence of impact modifier has a tendency to increase the oxygen permeability, it appears to have no significant negative effect on gasoline permeability in the compositions of the present invention as shown in Example 1, discussed above.

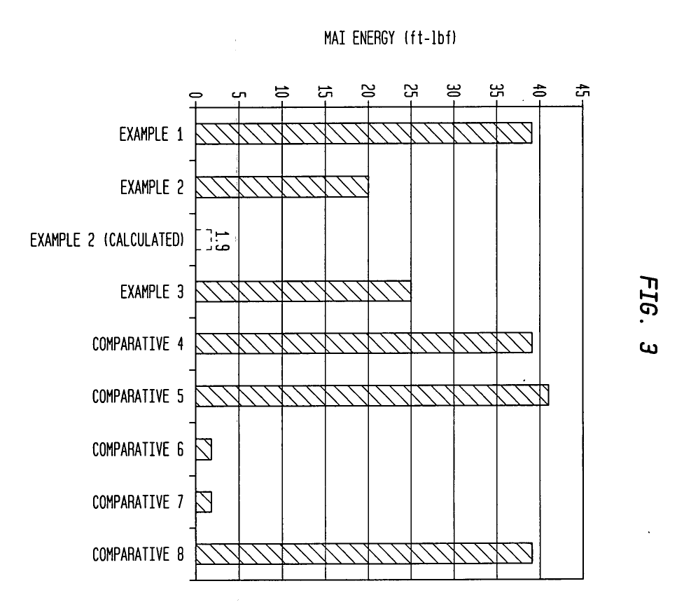

Another aspect of the present invention is the ability of the compositions to maintain good permeation characteristics while still providing sufficient strength. In this respect, the compositions of the present invention exhibit remarkably high MAI energy values. Comparative Examples 4 and 5 show that the impact modifier has a negative effect on MAI energy, decreasing the value by about 4.9%. And, when EVOH is added to PBT, the MAI value drops significantly by over 95%. Thus, when the impact modifier is mixed with the PBT/EVOH blend the MAI value would be expected to be less than the value of the PBT/EVOH blend without impact modifier, i.e., less than 1.9 ft-lbf. Surprisingly though, when impact modifier is added to PBT/EVOH, as in Example 2, a characteristic MAI energy of 20 ft-lbf is achieved. This a substantial improvement on the calculated value of 1.9 ft-lbf. Also, when talc is present as a nucleating agent in an amount of 0.15 wt. %, the MAI energy value of the sample is raised to 25 ft-lbf. The results of the MAI test for the Examples and the Comparative Examples are represented graphically in FIG. 3. The calculated MAI value for Example 2 (1.9 ft-lbf) is also shown in FIG. 3. Again, the superior strength properties of the compositions of the present invention are apparent from FIG. 3. Examples 1-3 show much higher MAI values than Comparative Examples 6 and 7. For instance, Example 1 has an MAI energy that is over 20 times greater than that of Comparative Example 6.

Another important comparison that can be seen from Table 2 is the characteristic notched izod impact strength of the compositions. Samples made from compositions of the present invention are able to achieve notched izod impact strength values which are higher than Comparative Examples 5-7. In some cases, the notched izod values for the compositions of the present invention are more than twice for those of the comparative examples. Thus, the compositions are able to maintain good strength properties while also exhibiting superior permeation characteristics. The combination of these properties make the inventive compositions especially suited for use in fuel tanks.

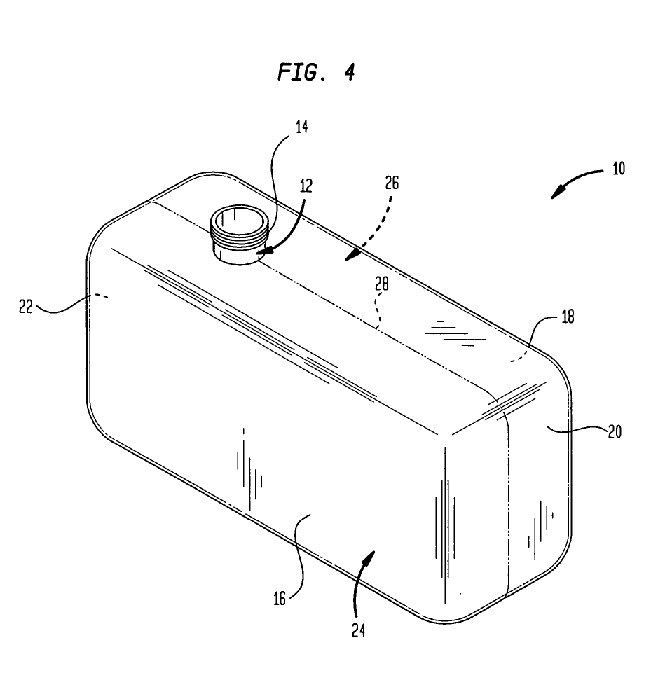

FIG. 4 illustrates a fuel tank 10 made in accordance with the present invention. The fuel tank 10 includes a neck 12 provided with threads 14 as well as a front wall 16, back wall 18 and side walls 20, 22. Tank 10 may be fabricated by way of a blow molding process with a front panel 24 and a back panel 26 with a mold pinch line there between indicated at 28.

While the invention has been described in connection with several examples, modifications to those examples within the spirit and scope of the invention will be readily apparent to those of skill in the art. In view of the foregoing discussion, relevant knowledge in the art and references including co-pending applications discussed above in connection with the Background and Detailed Description, the disclosures of which are all incorporated herein by reference, further description is deemed unnecessary.

What is claimed is:

1. An impact resistant, blended resin composition which exhibits low permeability comprising:
a polyester component which is selected from the group consisting of polyethylene terephthalate, polybutylene terephthalate, and copolymers or blends thereof, wherein the polyester component is present in an amount between about 20 PHR and about 90 PHR;
an olefin-vinylalcohol copolymer component present in an amount between about 5 PHR and about 60 PHR; and
an impact modifier component present in an amount between about 5 PHR to about 40 PHR.

2. The composition of claim 1, wherein the composition is melt-blended.

3. The composition of claim 1, wherein the polyester component is present in an amount between about 25 PHR to about 70 PHR.

4. The composition of claim 1, wherein said polyester component comprises polybutylene terephthalate.

5. The composition of claim 1, wherein said olefin-vinylalcohol copolymer component is present in the composition in an amount between about 7 PHR and about 25 PHR.

6. The composition of claim 1, wherein said olefin-vinylalcohol copolymer component comprises a copolymer of ethylene and vinylalcohol.

7. The composition of claim 6, wherein the ethylene-vinylalcohol copolymer has an ethylene content of between about 20 and about 40 mol %.

8. The composition of claim 6, wherein the ethylene-vinylalcohol copolymer is produced by the saponification of an ethylene-vinyl acetate copolymer, and wherein the degree of saponification is at least about 90 mol %.

9. The composition of claim 1, wherein said impact modifier component is present in an amount between about 10 PHR to about 35 PHR.

10. The composition of claim 1, wherein said impact modifier component comprises a core-shell modifier selected from the group consisting of MBS impact modifiers, acrylic impact modifiers, and combinations thereof.

11. The composition of claim 1, wherein said composition further comprises from about 0.01 PHR to about 20 PHR of other polymeric components.

12. The composition of claim 11 wherein said other polymeric components comprise a nylon.

13. The composition of claim 11 wherein said other polymeric components comprise a thermoplastic elastomer polyester resin.

14. The composition of claim 1, wherein the composition further comprises at least one component selected from the group consisting of nucleants, antioxidants, lubricants, and heat stabilizers.

15. The composition of claim 1, wherein said composition is blended with between about 0.01-50 wt. % of reinforcing agent, based on the weight of the blended composition.

16. The composition of claim 15, wherein the reinforcing agent comprises glass fiber.

17. A shaped article comprising the composition of claim 1.

18. The shaped article of claim 17, wherein said article is formed by extrusion.

19. A multilayered structure incorporating a layer of the composition of claim 1.

20. The multilayered structure of claim 19, wherein said structure further incorporates at least one layer comprising an oxymethylene polymer.

21. A container comprising the composition of claim 1.

22. The container of claim 21, wherein said container is formed by blow-molding.

23. The container of claim 21, wherein said container is formed by extrusion blow-molding.

24. The container of claim 21, wherein said container is formed by injection molding.

25. A fuel tank incorporating a composition which comprises:
a polyester component which is selected from the group consisting of polyethylene terephthalate, polybutylene terephthalate, and copolymers or blends thereof, wherein the polyester component is present in an amount between about 20 PHR and about 90 PHR;
an olefin-vinylalcohol copolymer component present in an amount between about 5 PHR and about 60 PHR; and
an impact modifier component present in an amount between about 5 PHR to about 40 PHR.

26. The fuel of claim 25, wherein the fuel tank has a wall with a thickness of between about 0.5 to about 6 mm and which wall consists essentially of the composition of claim 1.

27. The fuel tank in claim 25, wherein said fuel tank has a capacity of less than about 20 gallons.

28. The fuel tank according to claim 25, wherein said composition has a characteristic gasoline permeation of less than about 3 gm-mm/m²-day at 40° C.

29. The fuel tank according to claim 25, wherein said composition has a characteristic gasoline permeation of less than about 0.5 gm-mm/m²-day at 40° C.

30. The fuel tank according to claim 25, wherein said composition has a characteristic gasoline permeation of less than about 0.05 gm-mm/m²-day at 40° C.

31. The fuel tank according to claim 25, wherein said composition has a characteristic oxygen permeation of less than about 1 cc-mm/m²-day when tested at 23° C. with 100% oxygen on the test gas side of the diffusion cell at 1 atm.

32. The fuel tank according to claim 25, wherein said composition has a characteristic notched impact strength of at least about 7 kJ/m².

34. The fuel tank according to claim 25, wherein said composition has a characteristic MAI energy of at least about 18 ft-lbf when tested at an impact velocity of 7.2 ft/s.

35. The fuel tank according to claim 25, wherein said composition has a characteristic MAI energy of at least about 30 ft-lbf when tested at an impact velocity of 7.2 ft/s.

36. A method for making a fuel tank, said method comprising the steps of:
extruding a parison comprising a blend of polybutylene terephthalate, ethylene-vinylalcohol copolymer, and impact modifier, wherein said polybutylene terephthalate is present in an amount between about 20 PHR to about 90 PHR, said ethylene-vinylalcohol copolymer is present in an amount between about 5 PHR to about 60 PHR, and said impact modifier is present in an amount between about 5 PHR to about 40 PHR; and
blow-molding said parison into the shape of said fuel container.
